(19) United States
(12) Patent Application Publication
(10) Pub. No.: US 2020/0214219 A1
(43) Pub. Date: Jul. 9, 2020

(54) METHOD TO OPTIMIZE THE DENSITY OF THE BALE ON A ROUND BALER

(71) Applicant: DEERE & COMPANY, Moline, IL (US)

(72) Inventors: JONATHAN LEBEAU, DIJON (FR); MICHAEL COCARDON, POUILLEY LES VIGNES (FR); JEAN-ALEXIS MERCIER, MIREBEAU (FR)

(21) Appl. No.: 16/666,447

(22) Filed: Oct. 29, 2019

(30) Foreign Application Priority Data
Jan. 9, 2019 (EP) 19151009.8

(51) Int. Cl. A01F 15/08; A01F 15/07

(52) U.S. Cl. CPC A01F 15/0833; A01F 2015/077; A01F 15/07

(57) ABSTRACT

A round baler includes a baling chamber and a press means mounted within the baling chamber. A first sensor is disposed within the baler for sensing data related to a change in a diameter of a bale being formed in the baling chamber. A second sensor is configured to detect data related to a speed of the press means, such as a rotational speed of a drive shaft. The data related to the change of the diameter of the bale and the data related to the speed of the press means after each rotation of the bale are processed to determine a thickness of a layer of the crop material in the bale. The thickness is indicated in a display unit for an operator to view.

### CROSS-REFERENCE TO RELATED APPLICATIONS

This application claims the benefit of EP Patent Application No. 19151009.8, filed on Jan. 9, 2019, the disclosure of which is hereby incorporated by reference.

### TECHNICAL FIELD

The disclosure generally relates to a round baler. More particularly, the present disclosure relates a variable chamber round baler for providing an operator of the round baler with information on at least one parameter of a bale.

### BACKGROUND

A round baler includes a baling chamber wherein cut crop material is collected, formed into cylindrical layers to define a round bale, and then bound together. The baler includes one or more press means, such as but not limited to a pressing belt, which is transversely positioned within the baler. Typically, the bales are bound inside the baling chamber before being discharged on the ground. In a variable chamber baler, the press means is formed by one or more endless flexible belts. The width of the bale chamber is covered by the endless flexible belts and the sides of the bale chamber are covered by walls. The endless flexible belts are routed about rolls. In a variable chamber baler, the bale is formed by the endless flexible belts. The variable chamber baler includes a tensioning arm for maintaining tension in the endless flexible belts during baling. As the round bale increases in size, the endless flexible belts move to accommodate the increasing size of the bale, with the tensioning arm also moving to maintain a constant pressure between the endless flexible belts and the crop material.

To form bales of desired density, it is required to optimize the baling process. Currently, to optimize the baling process, the operator may be required to adjust the speed of a towing vehicle which tows and powers the baler. However, it might be difficult or not possible for the operator to determine the density of the bales, particularly the change in density of each layer of the crop material as the bale is being formed. This results in inefficient operation of the baler and causes dissatisfaction to the operator.

Hence, there is a need for a round baler with an arrangement to provide information to the operator of a variable chamber round baler about the change of density of each layer of the bale as the bale is being formed.

### SUMMARY

The problem addressed by the present disclosure is that of an inability of the operator to identify or determine a density of a bale as the bale is being formed, and increasing the efficiency of the baling process.

The present disclosure is defined by the claims, wherein in one embodiment a round baler includes a drive shaft, a pick-up unit operated by the drive shaft, a baling chamber with at least one rotating press means. The press means may include a flexible endless belt. The press means is routed through a plurality of rolling members.

The pick-up unit is configured to supply a crop material to the baling chamber. The rotating press means is configured to press crop material into a cylindrical bale formed by pressed layers of the crop material. The round baler includes a first sensor and a second sensor. The first sensor is configured to determine a diameter change of the bale within the baling chamber. The second sensor is configured to determine a speed of the press means while the bale is being formed in the baling chamber. For example, the second sensor may detect a speed of the drive shaft, and use the speed of the drive shaft to determine the speed of the press means. Alternatively, the speed of the drive shaft may be known from other parameters of the round baler, and used to determine the speed of the press means.

The round baler includes a controller, a processor and a display unit. The controller may be configured to receive sensed signals of the diameter change from the first sensor and also to receive information related to the speed of the press means from the second sensor.

The processor may be configured to process the speed and the diameter change to determine a thickness of a layer of the crop material. The processor is configured to determine the thickness of the layer corresponding to the rotation of the bale. The processor may calculate a time interval required for one rotation of the bale. The time interval may be determined as a function of the diameter change and the speed.

The first sensor may be at least one of a proximity sensor, an angle sensor and a potentiometer. The first sensor may be linked to a tensioning arm of the press means, wherein the tensioning arm pivots, moves or changes position according to the change in diameter of the bale. Alternatively, the first sensor may be mounted on any other portion which moves with the change in diameter of the bale. In a further embodiment, the first sensor may also be mounted on outer side of the press means. The second sensor may be a speed sensor. The speed sensor may be a hall-effect based sensor, accelerometer based sensor, variable reluctance speed sensors, eddy current speed sensor, etc.

The display unit may be configured to indicate thickness of the layer of the crop material for the bale. The display unit may indicate the thickness of the layer of crop material as a graphical representation or a numerical value.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a variable chamber round baler towed by a tractor.

FIG. 2 illustrates a sectional view of a baling chamber of the variable round baler with a plurality of rolls, flexible endless belt, the tensioning arm actuated by a hydraulic cylinder and a return spring, and showing a first embodiment for a sensor mounting.

FIG. 3 illustrates a sectional view of a baling chamber of the variable round baler with a plurality of rolls, flexible endless belt, the tensioning arm actuated by a hydraulic cylinder, and showing the first embodiment for a sensor mounting.

FIG. 4 schematically illustrates a block diagram for determining the thickness of a bale.

FIG. 5 illustrates a diameter of the bale at the end of the preceding rotation of the bale and a subsequent rotation of the bale.

FIG. 6 schematically illustrates a time duration for detecting the diameters of the bale at the end of each rotation.

FIG. 7 illustrates a sectional view of a baling chamber of the variable round baler with a plurality of rolls, flexible endless belt, the tensioning arm, and with an alternative embodiment for a sensor mounting.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “substantially” or “approximately” are understood by those of ordinary skill to refer to reasonable ranges outside of the given value, for example, general tolerances associated with manufacturing, assembly, and use of the described embodiments.

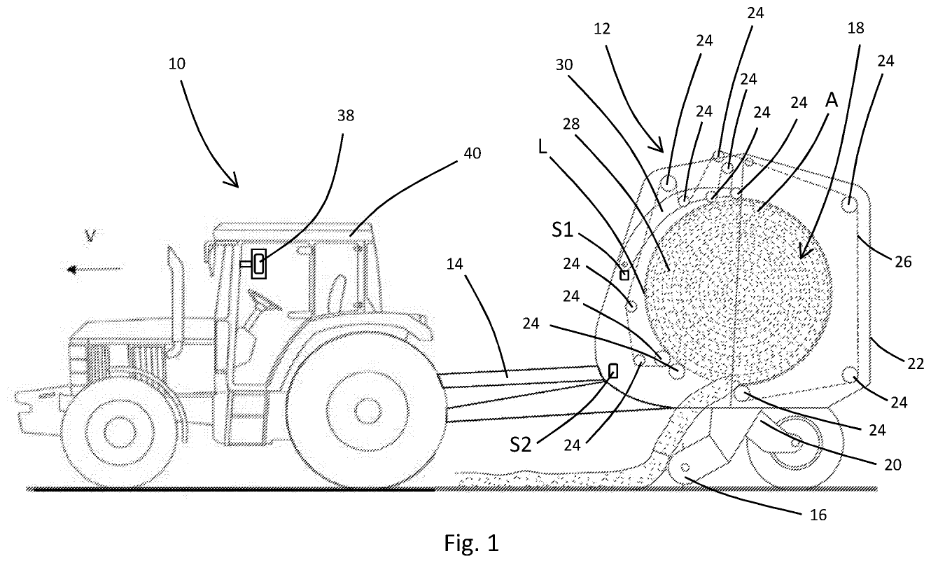

Referring to FIG. 1, a tractor (10) is used to tow a round baler (12) along the forward towing direction (V). The round baler (12) is a variable chamber baler. The round baler (12) is powered by a drive shaft (14), driven by a rotational input, such as a Power Transmission Shaft (PTO, not shown) of the tractor (10). Hereinafter, all indicated directions and location of the round baler (12), such as, forward, backward, rear, front, up, above, down, left and right shall be determined with reference to the forward towing direction (V) of the round baler (12) in the field. The round baler (12) includes a pick-up unit (16) provided at the front end of the round baler (12) to collect the residual product, such as hay, straw or other crop, from the ground and to convey it towards a cutting rotor (not shown), from which the crop enters into a baling chamber (18) of the round baler (12). The round baler (12) is mounted on a support frame (20) of a chassis (22) and includes the baling chamber (18) with a plurality of rolls (24) and a press means, such as but not limited to, a flexible endless belt (26), routed around and driven by the rolls (24). The round baler (12) is particularly a variable chamber baler, as illustrated in FIGS. 1-3 and 7.

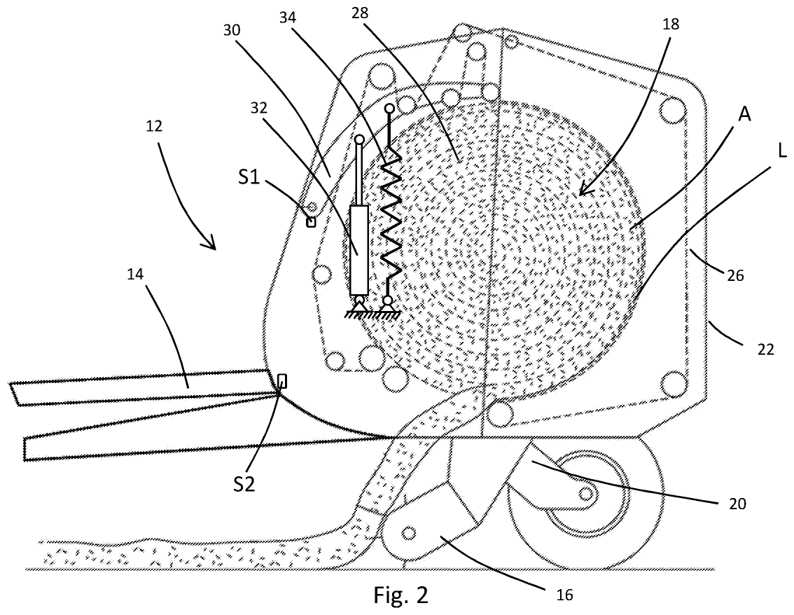

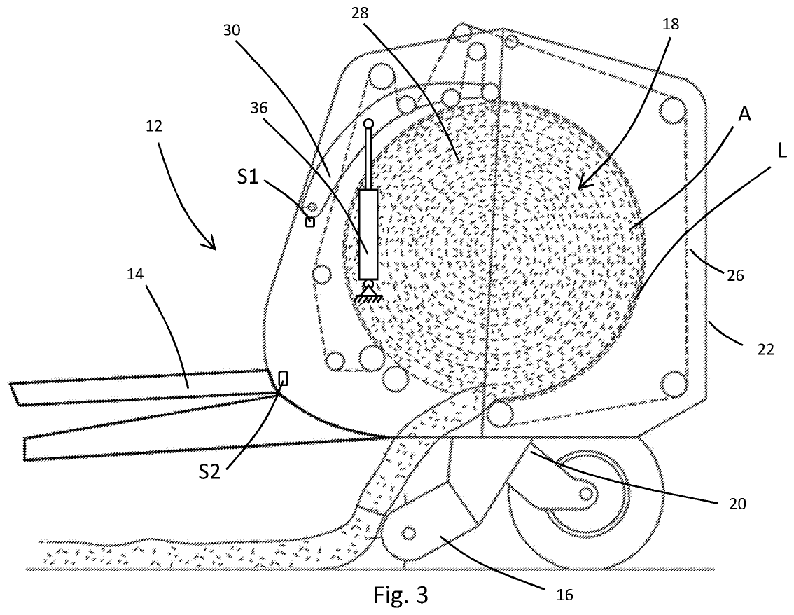

The flexible endless belt (26) is disposed within the baling chamber (18) and routed around the rolls (24). The drive shaft (14) is coupled to and rotates the flexible endless belt (26) in response to the rotational input. The flexible endless belt (26) continuously rotates and presses the crop material into pressed layers to form a bale (28). The round baler (12) includes a tensioning arm (30) to ensure appropriate tension is maintained in the flexible endless belt (26). As the size of the bale (28) increases, the tensioning arm (30) moves upwards in response to a growing loop (L) of the belt (26) around the growing bale (28) but maintains an optimum tension in the flexible endless belt (26). The tensioning arm (30) may be moved by a hydraulic cylinder (32) and a spring arrangement (34), as schematically illustrated in FIG. 2, or solely by a hydraulic cylinder (36), as schematically illustrated in FIG. 3.

Referring to FIGS. 1 to 3, a display unit (38) is provided in an operator station (40) of the tractor (10). The display unit (38) is configured to continuously indicate a change in a diameter of the bale (28). Data related to a change in the diameter of the bale (28) being formed in the bailing chamber (18) is detected by at least one first sensor (S1). In one example embodiment, the sensor (S1) is positioned on or linked to the tensioning arm (30) and responds to a movement of the tensioning arm (30). The first sensor (S1) may be a proximity sensor, an angle sensor, a potentiometer or any other kind of sensor which can be adapted to sense a respective movement or position of the tensioning arm. As discussed earlier, as the size of the bale (28) increases, the tensioning arm (30) moves upwards. Hence, the sensor (S1) instantaneously indicates the change of the size of the bale (28), in order that the change in the diameter of the bale (24) may be calculated. As such, the position of the tensioning arm (30) may be correlated to a size of the bale (28).

The speed of rotation of the plurality of rolls (24) and hence the operational speed of the flexible endless belt (26) is dependent on the speed of rotation (Vp) of the drive shaft (14), or the PTO respectively. Data related to the operational speed of the flexible endless belt while forming the bale (24) is sensed or detected by a second sensor (S2). In one example embodiment, the speed of rotation (Vp) of the drive shaft (14) is detected by the second sensor (S2). In other embodiments, the second sensor (S2) may be positioned to sense data related to the speed of the flexible endless belt (26) at some other location, such that the data is derived by other sensing means within the drive train of the tractor (10) or the baler (12), which indicates the rotation speed of the PTO.

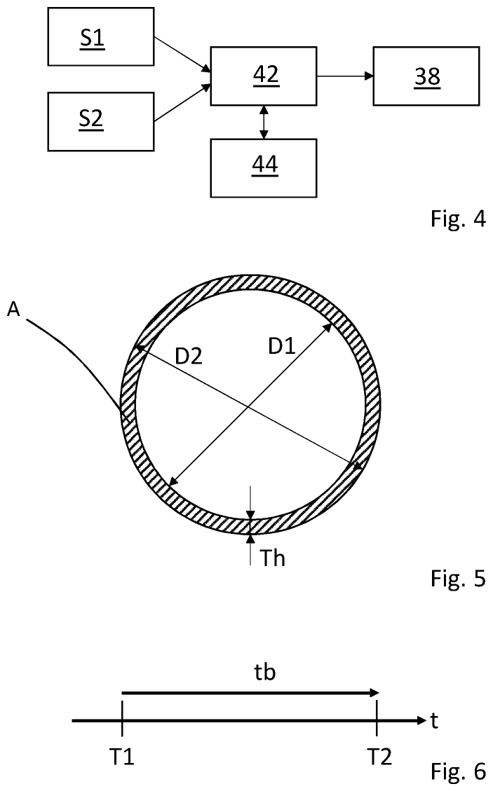

Referring to FIG. 4, FIG. 5, FIG. 6, a controller (42) is in communication with and receives the input, i.e., the data, from the first sensor (S1) and the second sensor (S2). The controller (42) may alternatively be referred to as a computer, a vehicle controller, a baler controller, a control module, a control unit, etc., the controller (42) may be located in the baler (12), the tractor (10), or remote from both the tractor (10) and the baler (12). The Controller (42) includes a processor (44) and a memory having a layer thickness determination algorithm saved thereon. The processor is operable to execute the layer thickness determination algorithm to implement a method of monitoring a thickness of a current layer of the round bale (28) being formed in a variable chamber round baler (12).

The processor (44) processes the signals received from the first sensor (S1) and the second sensor (S2) to derive a time interval (tb) for completing one rotation of the bale (28). Thus, for example, as illustrated in FIG. 5, a first diameter (D1) of the bale (28) is detected by the sensor (S1) at the end of a preceding rotation, at a first instant of time (T1), as indicated in FIG. 6. At the first instant of time (T1), when the diameter (D1) is detected, the processor (44) calculates a time interval (tb) that will be required to complete the subsequent rotation of the bale (28) at a second instant of time (T2). The calculation for the time interval (tb) is provided in equation (1).

$$t b = π \frac{D 1}{Vp} \qquad ( 1 )$$

After one rotation of the bale (28), one layer (A) of the crop material is added over the bale (28), thereby changing the first diameter (D1) of the bale (28) to a second diameter (D2) at the end of the preceding rotation. Thus, by adding the time interval (tb), derived from equation (1), to the first instant of time (T1), the processor (44) calculates the second instant of time (T2) when the subsequent rotation will be completed, derived from equation (2) and (3).

$$\begin{matrix}T 2 = T 1 + tb & ( 2 ) \\ T 2 = T 1 + π \frac{D 1}{Vp} & ( 3 )\end{matrix}$$

A second diameter (D2) of the bale (28), is detected by the first sensor (S1) at the second instant of time (T2) and considered by the processor (44) for further calculation of a layer thickness (Th) of the layer (A) derived from equation (4).

$$T h = \frac{( D 2 - D 1 )}{2} \qquad ( 4 )$$

As the processor (44) computes the first diameter (D1) and the second diameter (D2) for determining the thickness (Th) of the layer (A) of crop material added to the bale (28) between the first instant of time (T1) and the second instant of time (T2), the thickness (Th) of the layer (A) is indicated or displayed in the display unit (38).

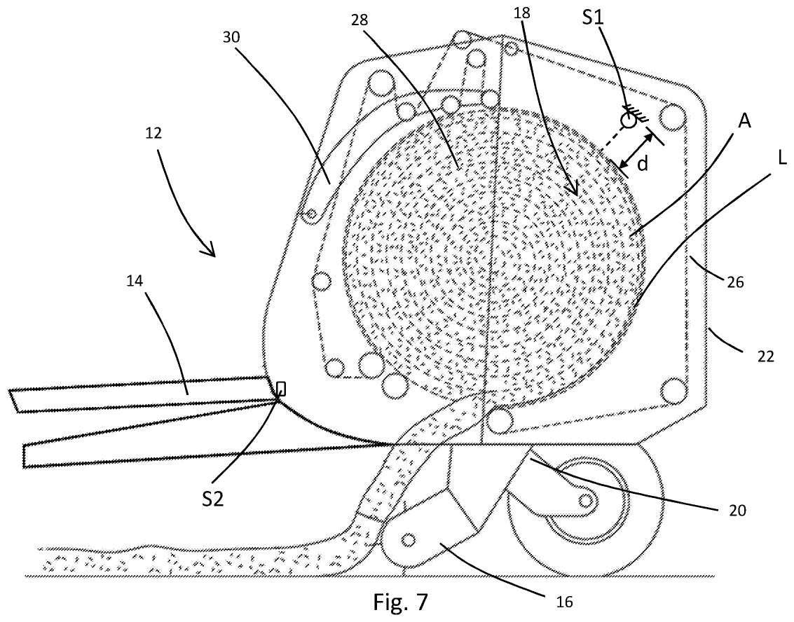

In accordance with an alternate embodiment, shown in FIG. 7, instead of having the first sensor (S1) positioned on or linked to the tensioning arm (30), the first sensor (S1) may be positioned at a fixed location on the inner side of the chassis (22) to detect a distance (d) from said fixed location to the surface of the endless belt (26) within a portion of the belt (26) where the belt is building the loop (L) which surrounds the bale (28). As the loop (L) grows during a baling process a distance (d) of the surface of the belt (26) within said loop (L) to the fixed location of the sensor (S1) decreases in proportion to the growing diameter of the bale (28). Due to a pre-given routing arrangement of the belt (26) around the rolls (24) and the geometrical dimensions and arrangement of the of the rolls within the baler (12), respectively, the change of the distance (d) from said fixed location to the surface of the endless belt (26) stays in proportional correlation to the change of diameter of the bale (28) and hence indicates the thickness (Th) of the layer (A) accordingly. Therefore, the sensor (S1), with a fixed location on the inner side of the chassis (22), detects the change of the distance (d) after each rotation of the bale (28) from which the thickness (Th) of the layer (A) can be derived and displayed in the display unit (38). In other words, in this embodiment, the distance (d) from said fixed location to the surface of the endless belt (26) at the second instant of time (T2) subtracted from the distance (d) from said fixed location to the surface of the endless belt (26) at the first instant of time (T1) is equal to the thickness (Th) of the layer (A). The first sensor (S1) in this embodiment may include, but is not limited to, an ultrasonic sensor.

Thus, in accordance with the present invention, the operator of the round baler (12) is updated about the thickness (Th) of each layer (A) of the bale (28). Using the information about the thickness (Th) of each layer (A) of the bale (28), the operator may be able to optimize the density of the bale (28). The information may be also used by the controller (42) to automatically adjust several parameters of the baler (12) to optimize the density of the bale (28). These parameters may include PTO speed, tractor speed, pick-up unit speed and tension of the endless belt (26) adjusted and maintained by the tensioning arm (30).

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A round baler comprising:
a support frame;
a baling chamber attached to the support frame;
a flexible endless belt disposed within the baling chamber, wherein the flexible endless belt is operable to press crop material into pressed layers forming a bale;
a first sensor operable to sense data related to a change in diameter of the bale being formed in the baling chamber;
a second sensor operable to sense data relate to a speed of the flexible endless belt while forming the bale in the baling chamber;
a controller in communication with the first sensor and the second sensor for receiving the data related to the change in the diameter of the bale and the speed of the flexible endless belt respectively, wherein the controller includes a processor operable to:
determine a thickness of a current layer of the bale being formed in the baling chamber from the data related to the change in diameter of the bale and the speed of the flexible endless belt; and
communicate a signal including the thickness of the current layer of the bale being formed in the baling chamber to a display unit.

2. The round baler set forth in claim 1, further comprising a tensioning arm coupled to the flexible endless belt and moveable in response to a change in diameter of the bale being formed in the baling chamber to maintain a tension in the flexible endless belt.

3. The round baler set forth in claim 2, wherein the first sensor is positioned to sense data related to a position of the tensioning arm.

4. The round baler set forth in claim 2, further comprising a hydraulic cylinder interconnecting the support frame and the tensioning arm, and operable to move the tensioning arm.

5. The round baler set forth in claim 4, further comprising a spring interconnecting the support frame and the tensioning arm, and operable to move the tensioning arm.

6. The round baler set forth in claim 1, wherein the first sensor includes one of a proximity sensor, an angle sensor, or a potentiometer.

7. The round baler set forth in claim 1, further comprising a drive shaft coupled to and operable to rotate the flexible endless belt in response to a rotational input.

8. The round baler set forth in claim 7, wherein the second sensor is positioned to sense a rotational speed of the drive shaft.

9. The round baler set forth in claim 1, wherein the first sensor is positioned at a fixed location on an inner side of the baling chamber to sense a distance from the fixed location to the flexible endless belt at a location where the flexible endless belt moves outward from a center of the bale being formed in the baling chamber as the diameter of the bale increases.

10. The round baler set forth in claim 1, wherein the processor is operable to execute the layer thickness determination algorithm to calculate a time interval required for one rotation of the bale within the baling chamber from the equation:
$$t b = π \frac{D 1}{V p} ;$$
wherein tb is the time interval required for one rotation of the bale within the baling chamber, D1 is a first diameter of the bale at a first time, and Vp is the speed of the flexible endless belt.

11. The round baler set forth in claim 10, wherein the processor is operable to execute the layer thickness determination algorithm to calculate a second time when a rotation of the bale immediately subsequent to the first time is completed, wherein the second time is calculated from the equation:
T2=T1+tb;
wherein T2 is the second time, T1 is the first time, and tb is the time interval required for one rotation of the bale within the baling chamber.

12. The round baler set forth in claim 11, wherein the processor is operable to execute the layer thickness determination algorithm to calculate the thickness of the current layer of the bale being formed within the baling chamber from the equation:
$$T h = \frac{( D 2 - D 1 )}{2} ;$$
wherein Th is the thickness of the current layer of the bale being formed within the baling chamber, D1 is the diameter of the bale at the first time, and D2 is the diameter of the bale at the second time.

13. A method of monitoring a thickness of a current layer of a bale being formed in a variable chamber round baler having a flexible endless belt for forming the bale, the method comprising:
sensing data related to a first diameter of the round baler at a first time with a first sensor;
sensing data related to speed of the flexible endless belt with a second sensor;
calculating a time interval required for one rotation of the bale immediately subsequent to the first time, with a controller, from the data related to the first diameter and the data related to the speed of the flexible endless belt;
calculating a second time, with the controller, from the first time and the time interval;
sensing data related to a second diameter of the bale at the second time with the first sensor;
calculating the thickness of the current layer of the bale being formed in the variable chamber round baler, with the controller, from the first diameter and the second diameter; and
communicating a signal indicating the thickness of the current layer of the bale to a display unit.

14. The method set forth in claim 13, further comprising calculating the first diameter of the bale, with the controller, from the data related to the first diameter of the bale sensed by the first sensor at the first time.

15. The method set forth in claim 13, further comprising calculating the speed of the flexible endless belt, with the controller, from the data related to the speed of the flexible endless belt sensed by the second sensor.

16. The method set forth in claim 13, further comprising calculating the second diameter of the bale, with the controller, from the data related to the second diameter of the bale sensed by the first sensor at the second time.

17. The method set forth in claim 13, wherein the variable chamber round baler includes a tensioning arm coupled to the flexible endless belt and moveable in response to a change in diameter of the bale being formed to maintain a tension in the flexible endless belt, and wherein the first sensor is positioned to sense data related to a position of the tensioning arm.

18. The method set forth in claim 13, wherein the variable chamber round baler includes a drive shaft coupled to and operable to rotate the flexible endless belt in response to a rotational input, and wherein the second sensor is positioned to sense a rotational speed of the drive shaft.

19. The method set forth in claim 13, wherein calculating the second time includes adding the time interval to the first time.

20. The method set forth in claim 13, wherein calculating the thickness of the current layer of the bale includes subtracting the first diameter from the second diameter to define a difference, and then dividing the difference by two.
